(19) United States
(12) Patent Application Publication
(10) Pub. No.: US 2010/0125482 A1
(43) Pub. Date: May 20, 2010

(54) Contractor Assessment

(75) Inventors: Garrett S. Burke, Boxborough, MA (US); Ming Y. Chow, Wakefield, MA (US)

Correspondence Address: OCCHIUTI ROHLICEK & TSAO, LLP, 10 FAWCETT STREET, CAMBRIDGE, MA, 02138, US

(73) Assignee: President and Fellows of Harvard College, Cambridge, MA (US)

(21) Appl. No.: 12/271,128

(22) Filed: Nov. 14, 2008

(51) Int. Cl. G06Q 10/00; G06Q 50/00

(52) U.S. Cl. 705/9; 705/7

(57) ABSTRACT

A contractor assessment system assists clients in identifying the best contractors for a large-scale construction project, including information on past performances (lagging indicators), strengths, and weaknesses (leading indicators). For example, clients can include owners, real estate developers, contractors, and insurance carriers.

### BACKGROUND

This invention relates to assessment of contractors.

Planning of construction projects typically involves selection of contractors, for example, selection of general and/or sub-contractors by an owner of a project, or selection of sub-contractors by a general contractor. A variety of factors may be involved in the selection process. One selection factor is a contractor's safety record, which may be particularly important, and in some situations, may dominate other factors, such as cost.

Safety factors may be important for a number of reasons. One reason is that safety-related events can have a significant impact on progress of a project. For example, a serious accident can delay a project due to shutdown time resulting from the accident. Another reason is that safety events can impact the cost of a project. For example, an owner may self-insure a construction project, and therefore, self-insurance costs can impact the overall project cost if there are indeed significant accidents. Another reason is that safety-related events can result in legal liability, for example, for injuries or property damage resulting from an accident.

Therefore, it can be critical that the best contractors are used to perform a large-scale construction project. The expectations for any construction project are that building codes, regulatory standards, especially that relating to health and safety, are met. The results of shoddy, unsafe, and unhealthy construction jobs can significantly impact the client and contractors legally and financially, during and after the construction project.

### SUMMARY

In a general aspect, a contractor assessment system assists clients in identifying the best contractors for a large-scale construction project, including information on past performances (lagging indicators), strengths, and weaknesses (leading indicators). For example, clients can include owners, real estate developers, contractors, and insurance carriers.

In another aspect, in general, a contractor assessment system includes an interface for contractors to provide information to the system. The information can include safety related information. A score generator processes information provided to the system by a contractor to determine a safety related score for the contactor. An interface for clients is used to identify one or more services desired by the client and to receive a selection of contractors identified according to safety scores for the contractors.

Aspects can include one or more of the following.

The safety related information includes solicited information and documentary evidence, and the system further includes a validation module configured to validate the solicited information according to the documentary evidence.

The validation module includes an association of solicited information and keywords, and the validation module is configured to determine the presence of keywords in validating solicited information.

In another aspect, in general, a method for selecting contractors includes accepting safety related information from a number of contractors. A safety score is evaluated for each of the contractors based on the solicited safety related information. Project-related information is accepted from a client. A selection from the contractors is provided according to the evaluated safety scores for the contractors.

Aspects can include one or more of the following.

Accepting the safety related information includes accepting answers to a set of questions provided to the contractor by the system.

Accepting the safety related information can further include accepting documentary evidence from the contactors. The accepted answers can be validated according to the documentary evidence. Validating the accepted answers can include determining a set of keywords associated with the answer, and determining the presence of the keywords in the documentary evidence.

Accepting project-related information from the client includes accepting a specification of a set of services required for the project. Providing the selection of contractors includes providing a selection of contractors for each of the services required for the project.

In another aspect, in general, software stored on a computer readable medium comprising instructions for causing a data processing system to perform all the steps of any of the methods described above.

Other features and advantages of the invention are apparent from the following description, and from the claims.

### DESCRIPTION OF DRAWINGS

FIG. 1 is a block diagram of an assessment system.

FIG. 2 is a diagram of elements of a database of the assessment system.

FIG. 3 is a diagram illustrating contractor survey questions.

### DESCRIPTION

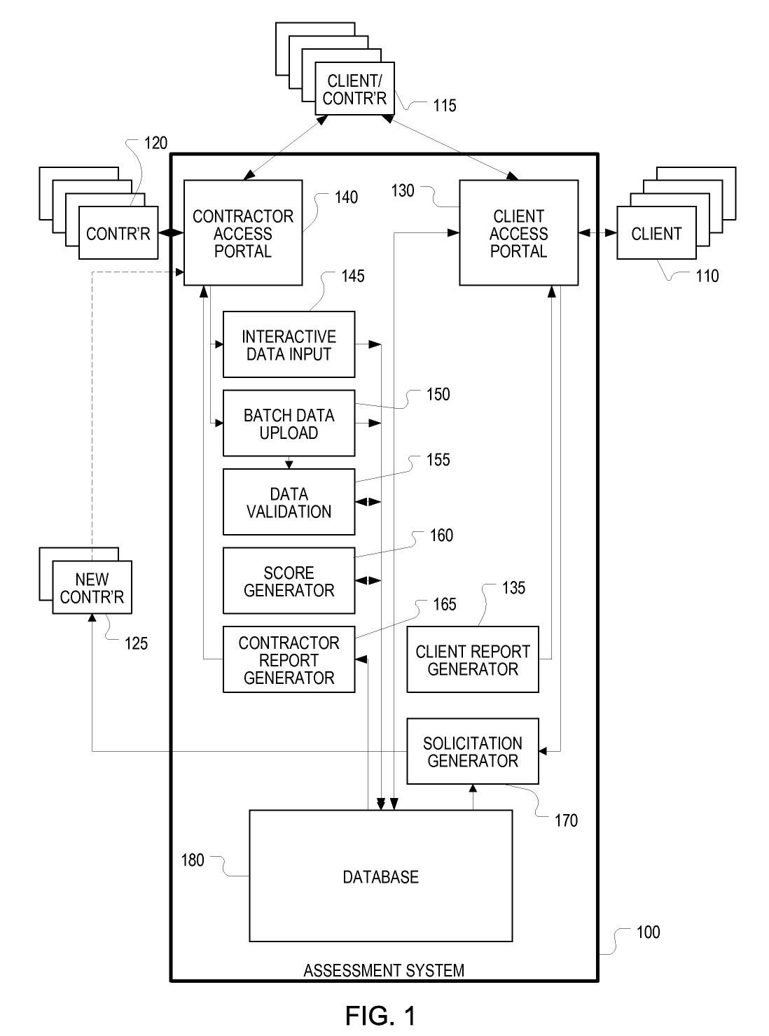

Referring to FIG. 1, an assessment system 100 provides services related to contractor assessments. Users of the system include clients 110, who include, for example, owners of projects who seek to identify potential contractors (e.g., prime and/or sub-contactors) for particular projects. Other users are contractors 120, who use the system to provide information that is then used by the system in identifying contractors to clients. Some users 115 act both in the role of clients and contractors. For example, a prime contractor may act in the role of a client from the point of view of identifying sub-contractors for a project, and may act as a contractor from the point of view of an owner/client who is seeking to identify a potential prime contractor for a project.

The assessment system 100 includes a client access portal 130 and a contractor access portal 140. In some embodiments, the system makes use of the Internet allowing clients and contractors to access the system using a Web (“World Wide Web”) interface. The system may provide restricted access based on username and password access control. In some embodiments, other forms of distributed or server-based software architecture are used to provide the same or similar services to users. For example, some versions of the system may be tailored to provide services to a single owner/client, and provide access to contractor users. As another example, information may be shared between different instances of the system while having dedicated instances of the system for particular clients.

One function of the assessment system is to acquire safety related information from contractors, and to provide a processed version of that information to clients to aid their selection of one or more contractors for a particular project. The system supports various modes and corresponding functional modules of the system for acquiring information from contractors. Examples of acquisition of information include accepting answers to survey questions, and accepting documentary evidence.

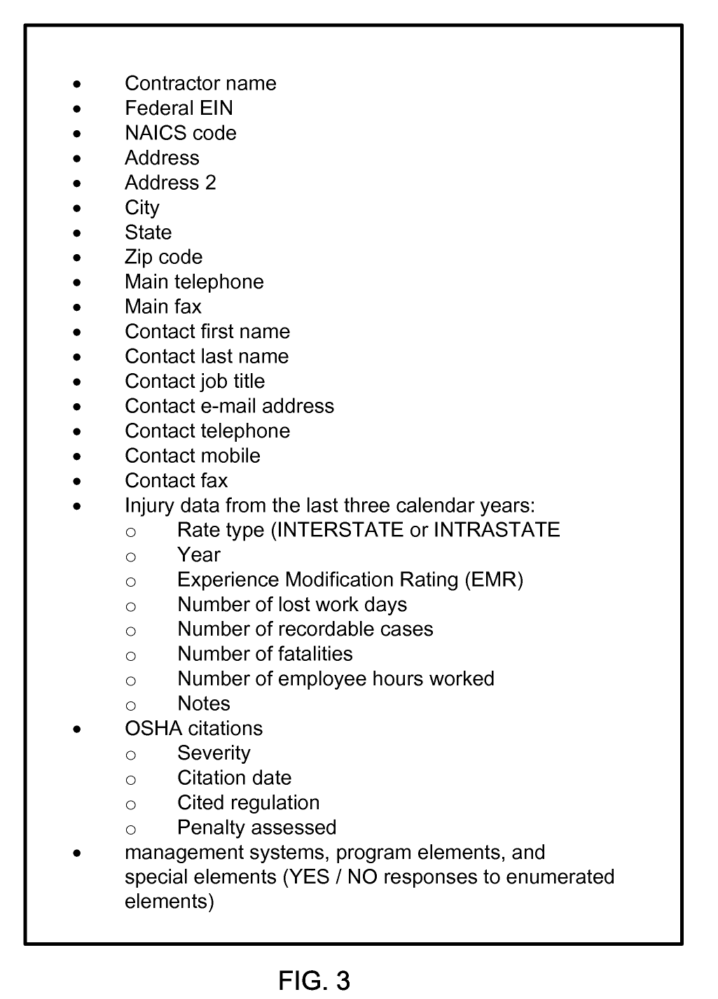

An interactive data input module 145 is configured to solicit and accept answers to survey questions from a contractor. Referring to FIG. 3, an example of a set of survey questions that are provided to the contractor include identification questions (e.g., Name, EIN, etc.), as well as safety related data, such as injury data from the last three calendar years and OSHA citation data. The questions also solicit information regarding the contractor's activities or program that may increase safety, such as use of particular management system, conducting of particular safety training or programs. In some examples, (not shown), the contractor is presented with a list of possible elements (e.g., management system, training programs, etc.) and indicates yes or no for each element.

A batch upload module 150 is configured to solicit and accept documentary evidence from the contractor. For example, the contractor can upload a document describing a safety program or an insurance certificate document. In some examples, the documentary evidence is provided in an electronic text form (e.g., in a format for a text editor, such as Microsoft Word, or as an ASCII file). In some examples, the documentary evidence is provided in an electronic image form, for example, produced by scanning a paper document, using a format such as TIFF (Tagged Image File Format) or PDF (Portable Document Format). In some embodiments, the documentary evidence may be accepted in other ways, for example, as facsimile transmissions over a telephone network. In examples in which the documentary evidence is provided in image form, an Optical Character Recognition (OCR) process is applied to the documents to form machine readable text forms of the documents.

The system also includes a data validation module 155. One function of the validation module is to compare responses to the survey questions with the content of evidentiary documents. As an example, if a contractors answers “YES” to having a particular safety program, then documents are scanned for relevant keywords that would be indicative of such a program. If such keywords are found, the answer is accepted by the system. If such keywords are not found, then the “YES” answer is indicated as requiring further review, for example, by a human operator of the assessment system to confirm that the “YES” answer is accurate. In some examples, the lack of corresponding keywords is used to annotate the response as unverified without performing any further confirmation. In some embodiments, each answer to a question is associated with a set of representative keywords that are to be searched for to confirm the answer. For example, an answer “YES” to having a particular management system may be associated with presence of particular keywords in a Safety Programs document. In some examples, different categories of documentary evidence may be uploaded by the contractor, and in addition to specification of representative keywords that are associated with an answer, the specification includes a category or categories of documents in which the keywords are to be found.

After entry of interactive input, uploading of evidentiary documents, and validation of the answers in the interactive input, the validated information is stored in association with the contractor in a database 180.

The assessment system 100 also includes a score generator 160, which uses the information provided by a contractor to compute a score indicative of a degree of quality of the contractor. In some examples, the score provides a measure of completeness of the contractor's responses and a safety performance of the contractor.

In some examples, the score generator 160 uses a predefined formula using information included in the following three data sets:
The quality of the corporate safety program for each contractor
   Management program elements
   Individual safety program elements
   Special program elements
Injury and work data
OSHA citations data

Depending on the types of service performed by a contractor, each of the three data sets is also weighted based upon its impact in predicting safety performance. The weighting system strikes a balance between small and large contractors. Large contractors are more likely to have more documented safety programs and owners commitment due to their resource capacity. Large contractors are also more likely to have an OSHA inspection. Finally, their experience modification rating (EMR) is likely lower due to the large office staff that is part of the organization.

In some embodiments, the score generator 160 implements a score normalization function, which attempts to compensate for disparities between contractors that may not truly represent safety factors, but which may be due to factors such as company size, geographic location, contractor's trade, etc. In some examples, this normalization is based on statistical distributions of factors; in some examples, heuristic rules are used to implement the normalizations.

The score calculated by the score generator 160 is stored in the database 180.

The assessment system 100 also includes a contractor report generator 165, which may provide a summary report that can include the calculated score for the contractor. In some examples, the report identifies factors that negatively impact the contractor's score and/or factors that positively impact the score. In some examples, the report also provides comparative information with respect to other contractors, for example, showing distributions of answers for other contractors in the same trade, in the same geographic area.

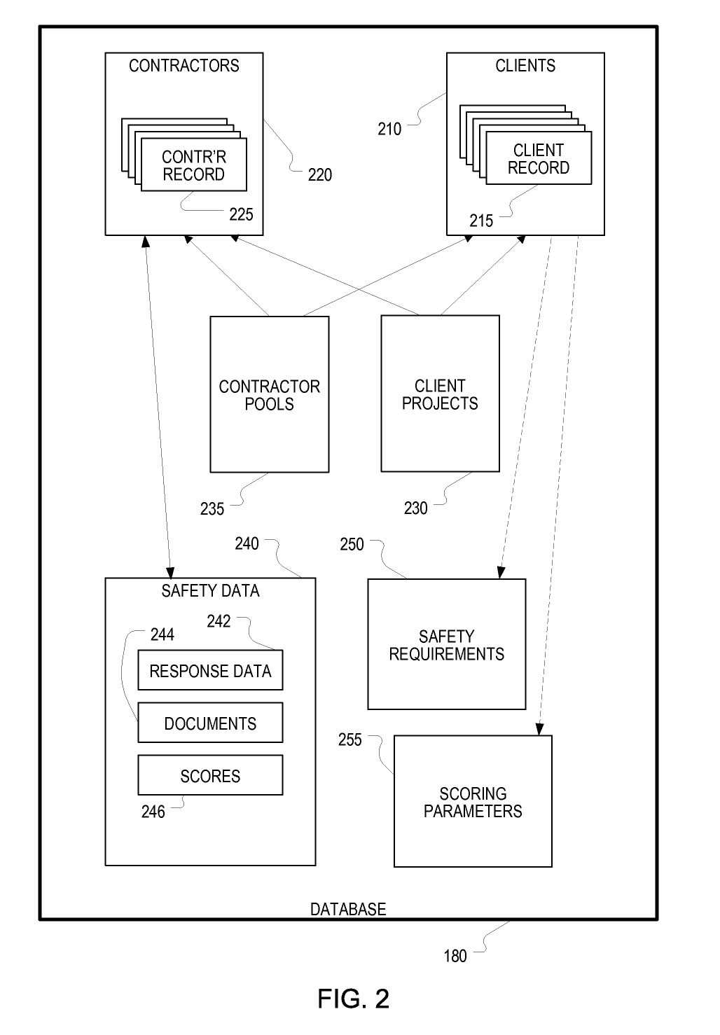

Referring to FIG. 2, the information provided by a contractor is stored in the database 180 in association with a contractor record 225. Specifically, a safety data storage 240 includes the raw response data 242 (optionally annotated according to the validation of the data), documents 244 including the uploaded evidentiary documents, and scores 246 computed by the score generator 160.

Referring again to FIG. 1, clients 110 (e.g., owners) access the assessment system 100 via a client access portal 130. In some examples, the client access portal is implemented using the same technologies as the contractor access portal 140 (e.g., as a Web server). Access by clients is username and password protected. In some examples, multiple user accounts may be associated with a particular client, for example, to provide access by different employees of an owner.

Referring to FIG. 2, the client portal 160 provides an interface for clients for maintaining information in the database 180. Each client may maintain a pool of contractors that they wish to consider when seeking contractors for a particular project. For example, for each trade, the client may select a number of contractors for their contractor pool. In FIG. 2, contractor pools 235 represents a set of records that associate each client record 215 with a set of one or more contractor records 225.

Referring again to FIG. 1, a client may wish to add to his pool a contractor that is not already registered with the assessment system. In that case, the client causes a solicitation generator 170 to solicit the contractor to provide their information to the system. For example, the client may provide contact information, such as an email address or a postal mailing address, and solicitation generator sends a request to the contractor with instructions for accessing the assessment system. For example, an email to the contractor may provide a Web link that the contractor may use to access the contractor access portal 140.

Referring again to FIG. 2, each client may have one or more projects for which the client is seeking to select contractors or projects that are already under way with selected contractors. For each project, the client specifies identifying information (e.g., a name), as well as an identification of the set of types of contractors required for the project, for example, according to trade identifiers (e.g., NAICS codes).

A function provided by the client access portal 130 is to use the information associated with a project to list potential contractors for each of the trades or functions identified for the project. In some examples, these contractors are presented in rank order according to their overall scores, for example, truncated to a maximum number of potential contractors for each trade or function.

In some embodiments, the potential contractors for a project are presented to the client in a hypertext format, allowing the client to select a contractor (e.g., “click” on a contractor's link) and view more specific information about the client. For example, information similar to a contractor's report, which may show strengths and weaknesses of the contractor as well as the contractor's overall score, is provided.

The assessment system also includes a client report generator 135. One function of the report generator is to generate a summary report for a client project, listing potential clients for each of the functions of a project.

Once the client selects the contractors for a project, that selection is also recorded in the system. This provides the client with access to a history of contractors used on various projects.

An optional feature of the assessment system 100 is for a client to provide client-specific safety requirements, for example, specifying particular questions to be answered or items of information to be provided by a contractor. For example, a client may have a unique need or desire that they want to evaluate. Also as an optional feature, a client may specify client-specific scoring parameters. For example, a particular client may wish to weigh certain factors more highly than is the default for the system.

In certain cases, the system solicits updates to information from contractors who are already registered with the system. For example, updates to certain information may be requested whenever a client seeks scored selections for a new project. In some examples, certain information expires, and the system solicits updates to expired information. In some examples, if a client wishes to have information that is unique to that client, or other information that has not been collected, the system can solicit that particular information from the relevant contractors (e.g., the contractors in the client's pool).

In some embodiments, a new contractor 125 may not be solicited by a client, but may nevertheless wish to be considered for projects by clients of the assessment system 100. In such cases, a new contractor may access the contractor portal without solicitation and provide information to the system. This contactor is placed into a general pool that is not tied to any particular client. In such embodiments, in addition to providing possible choices to a client from that client's contractor pool, the system may also provide additional choices from the general pool. For example, the choices from the general pool may be ranked and interspersed with the contractors from the client's pool, or they may be presented separately.

As introduced above, certain users 115 may act as both contractors and clients. For example, a general contractor may provide information to the assessment system as a contractor seeking selection by an owner. On the other hand, the general contractor may also use the system as a client, seeking information about potential subcontractors for a project they wish to be chosen for.

In some embodiments, the assessment system 100 provides an export function to clients, for example, for populating contractor information in a project management system. In this way, information entered by a contractor is used directly without it having to be reentered by the owner of a project.

As introduced above, one implementation of the assessment system 100 is as an independent service operated by a third party that is neither an owner nor a contractor. In some instances, the owners pay fees to the operating party, in other instances the contractors pay the fees, and in some instances both owners and contractors pay fees for use of the system. In another implementation, the system is provided to an owner or a general contractor to operate as an independent system. In some examples, multiple instances of the assessment system operate substantially independently, but contractor information is shared between the instances so that a contractor does not have to re-enter their information for each instance. For example, multiple general contractors may each operate an instance of the system, with sub-contractor information being shared between instances.

In some embodiments, the party operating the assessment system 100 functions as a certification authority for the contractors. For example, the system may provide a certification report to the contractor showing their overall score, optionally in comparison with other contractors. The contractor can then provide the certification report to other parties, for example, insurers, as evidence of their safety level. For example, an insurer may provide a lower premium to a contractor with a higher score.

A number of exemplary use cases show how functions of embodiments of the assessment system may be used. In a first use case an existing client user, Eric, is the project manager for the renovation of a historic landmark in Lexington, Mass., funded by the city. The three services that are needed for the project are concrete, earthwork, and electrical. Because of the nature of the job, it is critical that the best contractors are used and the renovation is on budget. Eric logs on to the assessment system and views the list of all prospective contractors for each of the three services. All the prospective contractors are within 20 miles of Lexington, Mass. For each service, the prospective contractors are listed by their overall score with top score listed first. Next, Eric wants to view the profile of the top candidate for the electrical work, and clicks on the contractor listed. On the profile, Eric views the overall score, strengths, weaknesses, and client relationships of the contractor.

In a second use case, a new owner client, Randal, works at a leading construction firm, and is hired to manage the development of a new office tower for his boss in Chicago, Ill. The development will require over two dozen trades. Randal creates a new project profile on the assessment system. In creating the new account, Randal is asked to provide a brief description of the project, the location of the project, and the trades required. On successful account creation, Randal will see a list of all prospective contractors, generated from the firm's master list of contractors, for each of the services requested, sorted by overall score.

In a third use case, Shaun is the president of an electrical contracting company that services a major football stadium. His next goal is to service a major U.S. military facility. Knowing that the standards of receiving a military contract are extremely high, Shaun wants to make sure that the image and the quality of service are unparallel to other electrical contractors. He logs into the assessment system. The system recognizes that Shaun is a contractor, and displays information about his company. He notice that overall, his services are good, but his score is lower than that of two other contractors. According to records, there have been no serious OSHA violations with his contractor, but the loss work day rate is slightly above the national average. Shaun hires a consultant to help create better safety management systems to increase his score. Shaun takes the portfolio to his insurance broker to demonstrate his safety management systems. The insurance broker reduces his premium by 10%.

The description above focuses on safety related assessment of contractors. In some embodiments, other assessments of contractors may be included in addition to or instead of safety. For example, cost, timeliness, minority representation, etc., may be included and scores that are not solely safety related may be generated by the system.

The approaches described above have contractor information being provided by the contractors themselves. In some embodiments, information about contractors may be obtained by the system or provided to the system from other sources. For example, publicly available databases may provide employer information (e.g., size, locations), financial information (e.g., annual revenue), that is integrated into a contractor's profile. In some embodiments, clients may also provide information about contractors, such as private assessments, which are factored into a contractor's overall score.

The approaches described above may be implemented in software, for example, embodied as instructions stored on or transmitted over computer readable media. In some embodiments, the instructions cause a data processing system to perform the operations described above. The data processing system may include a network-based system in which users access functions of the system over a data network. In some embodiments, functions may be hosted on distributed computers, for example, with some functions being hosted on a user's computer (e.g., within a user's browser software) and some functions being hosted on a server computer for the assessment system.

It is to be understood that the foregoing description is intended to illustrate and not to limit the scope of the invention, which is defined by the scope of the appended claims. Other embodiments are within the scope of the following claims.

What is claimed is:

1. A contractor assessment system comprising:
an interface for contractors to provide information to the system, including safety related information;
a score generator for processing information provided to the system by a contractor to determine a safety related score for the contactor; and
an interface for clients to identify one or more services desired by the client, and to receive a selection of contractors identified according to safety scores for the contractors.

2. The system of claim 1 wherein the safety related information includes solicited information and documentary evidence, and the system further comprises a validation module configured to validate the solicited information according to the documentary evidence.

3. The system of claim 2 wherein the validation module includes an association of solicited information and keywords, and the validation module is configured to determine the presence of keywords in validating solicited information.

4. A method for selecting contractors comprising:
accepting safety related information from a plurality of contractors;
evaluating a safety score for each of the contractors based on the solicited safety related information;
accepting project-related information from a client; and
providing a selection from the plurality of contractors according to the evaluated safety scores for the contractors.

5. The method of claim 4 wherein accepting the safety related information includes accepting answers to a set of questions provided to the contractor by the system.

6. The method of claim 5 wherein accepting the safety related information further includes accepting documentary evidence from the contactors.

7. The method of claim 6 wherein accepting the safety related information further includes validating the accepted answers according to the documentary evidence.

8. The method of claim 7 wherein validating the accepted answers includes determining a set of keywords associated with the answer, and determining the presence of the keywords in the documentary evidence.

9. The method of claim 4 wherein accepting project-related information from the client includes accepting a specification of a set of services required for the project, and wherein providing the selection of contractors includes providing a selection of contractors for each of the services required for the project.

10. Software stored on a computer readable medium comprising instructions for causing a data processing system to:
accept safety related information from a plurality of contractors;
evaluate a safety score for each of the contractors based on the solicited safety related information;
accept project-related information from a client; and
provide a selection from the plurality of contractors according to the evaluated safety scores for the contractors.
